(19) United States
(12) Patent Application Publication
(10) Pub. No.: US 2025/0242744 A1
(43) Pub. Date: Jul. 31, 2025

(54) TRAILER WITH VARIABLE LOAD HEIGHT

(71) Applicant: Schneider Enterprise Resources, LLC, Green Bay, WI (US)

(72) Inventors: Michael Nieman, Lowell, NC (US); Dan Drella, Green Bay, WI (US); Ken Vaughn, De Pere, WI (US); Tony Evans, Randleman, NC (US)

(73) Assignee: Schneider Enterprise Resources, LLC, Green Bay, WI (US)

(21) Appl. No.: 18/422,310

(22) Filed: Jan. 25, 2024

(51) Int. Cl. B60P 7/08

(52) U.S. Cl. CPC B60P 7/08

(57) ABSTRACT

A load kit for supporting a load on a flatbed of a trailer includes a cross member, a first support, and a second support. The cross member is configured to extend across a lateral width of the flatbed and selectively couple to the trailer. The cross member includes a first brace and a second brace laterally spaced from the first brace. The first support is configured to be received by the first brace and extend along at least a portion of a longitudinal length of the flatbed. The second support is configured to be received by the second brace and extend along at least a portion of the longitudinal length of the flatbed.

### BACKGROUND

This application generally relates to a trailer for carrying cargo and transporting the cargo. Flatbed trailers are commonly used for transporting variously shaped and sized cargo. Traditionally, fastening mechanisms and support systems used to fasten and support the cargo lack the adaptability to transport the variously shaped and sized cargo.

### SUMMARY

One embodiment relates to a load kit for supporting a load on a flatbed of a trailer. The load kit includes a cross member, a first support, and a second support. The cross member is configured to extend across a lateral width of the flatbed and selectively couple to the trailer. The cross member includes a first brace and a second brace laterally spaced from the first brace. The first support is configured to be received by the first brace and extend along at least a portion of a longitudinal length of the flatbed. The second support is configured to be received by the second brace and extend along at least a portion of the longitudinal length of the flatbed.

Another embodiment relates to a trailer for a truck. The trailer includes a chassis, a flatbed coupled to the chassis, a plurality of interfaces positioned along a longitudinal length of the chassis, a plurality of cross members, a plurality of first supports, a plurality of second supports, and a storage rack. The plurality of cross members is configured to selectively engage with the plurality of interfaces. The plurality of first supports is configured extend along at least a portion of the longitudinal length of the trailer, and is configured to selectively couple with the plurality of cross members. The plurality of second supports is configured extend along at least a portion of the longitudinal length of the trailer and be laterally spaced from the plurality of first supports, and is configured to selectively couple with the plurality of cross members. The storage rack is configured to couple to the chassis. The storage rack is configured to selectively store the plurality of cross members, the plurality of first supports, and the plurality of second supports.

Another embodiment relates to a method for converting a trailer having a flatbed and interfaces positioned along opposing sides of the flatbed. The method includes providing a cross member, a first support, a second support, a first pin, a second pin, a third pin, and a fourth pin. The cross member has a first retainer positioned at a first end thereof, a second retainer positioned at opposing second end thereof, a first brace positioned between the first end and the second end closer to the first end, and a second brace positioned between the first end and the second end closer to the second end. The method further includes inserting the first retainer into a first interface of the interfaces and the second retainer into a second interface of the interfaces such that the cross member extends across a lateral width of the flatbed; inserting the first pin through the first retainer to secure the first retainer within the first interface; inserting the second pin through the second retainer to secure the second retainer within the second interface; disposing the first support within the first brace; disposing the second support within the second brace; inserting the third pin through the first brace and the first support to secure the first support to the cross member; and inserting the fourth pin through the second brace and the second support to secure the second support to the cross member.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE FIGURES

FIG. 1 is a top view of a load kit installed on a flatbed trailer, according to an exemplary embodiment.

FIG. 2 is a side view of the load kit installed on the trailer of FIG. 2 with rolled pipe supported on the flatbed trailer by the load kit, according to an exemplary embodiment.

FIG. 3 is a front, left perspective view of a cargo transportation vehicle including the flatbed trailer of FIG. 1, according to an exemplary embodiment.

FIG. 4 is a rear perspective view of the cargo transportation vehicle of FIG. 3 including the flatbed trailer with the load kit installed, according to an exemplary embodiment.

FIG. 5 is a rear, right perspective view of the cargo transportation vehicle of FIG. 3 including the flatbed trailer with the load kit installed, according to an exemplary embodiment.

FIG. 6 is a perspective view of a cross member of the load kit of FIG. 1, according to an exemplary embodiment.

FIGS. 7 and 8 are side views of the cross member of FIG. 6 coupled to the flatbed trailer of FIG. 1, according to an exemplary embodiment.

FIG. 9 is an interior side view of the cross member of FIG. 6 coupling a support to the flatbed trailer of FIG. 1, according to an exemplary embodiment.

FIG. 10 is a top view of the cross member of FIG. 9 coupling the support to the flatbed trailer of FIG. 1, according to an exemplary embodiment.

FIGS. 11 and 12 are perspective views of a storage rack included in the load kit of FIG. 1 and carrying a plurality of cross members and supports of the load kit, according to an exemplary embodiment.

FIG. 13 is a top view of the load kit of FIG. 1 installed on a rear portion of the flatbed trailer, according to an exemplary embodiment.

### DETAILED DESCRIPTION

Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

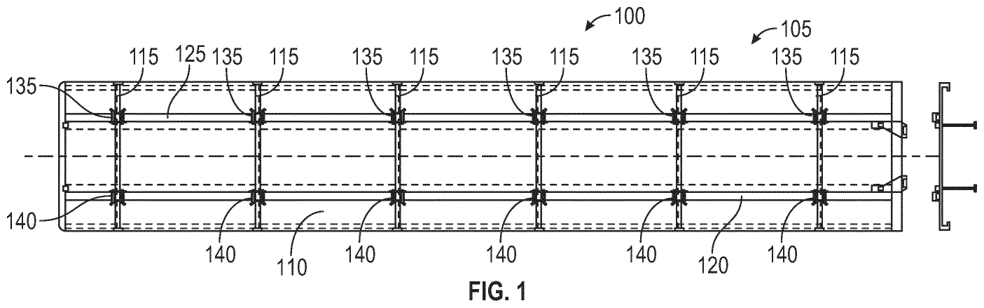

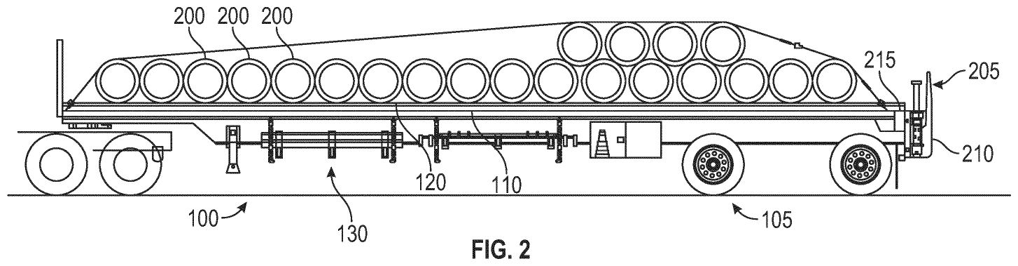

As shown in FIGS. 1 and 2, a load securing kit (e.g., a pipe securing system, a varying load height apparatus, etc.), shown as load kit 100, is configured to selectively couple to a trailer (e.g., flatbed, rear assembly, module, implement, body, cargo area, application kit, etc.), shown as trailer 105. The load kit 100 is configured to support a load and vertically space the load from a surface, floor, or deck of the trailer 105. The load kit 100 includes one or more frames (e.g., board bracings, braces, load support members, rails, 4×4 wood lumber posts, 4×6 wood lumber posts, etc.), shown as cross members 115, a first set of supports (e.g., planks, boards, load supports, rails, risers, etc.), shown as first supports 120, a second set of supports (e.g., planks, boards, load supports, rails, risers, 4×4 wood lumber posts, 4×6 wood lumber posts, etc.), shown as second supports 125, and a storage rack (e.g., rail storage, support storage, etc.), shown as storage rack 130. The cross members 115, the first supports 120, and the second supports 125, are configured to selectively couple to the trailer 105, thereby facilitating modularity of the trailer 105, such that the trailer 105 is capable of supporting two or more different types of loads (e.g., circular loads, round loads, curved bottom or shaped loads, square loads, rectangular loads, flat bottom loads, etc.). A method for converting the trailer 105 such that the trailer 105 is capable of supporting two or more different types of loads includes installing the load kit 100 onto the trailer 105 to facilitate varying a load height (e.g., a vertical distance between a surface, floor, or deck of the trailer 105 and the load) of the trailer 105.

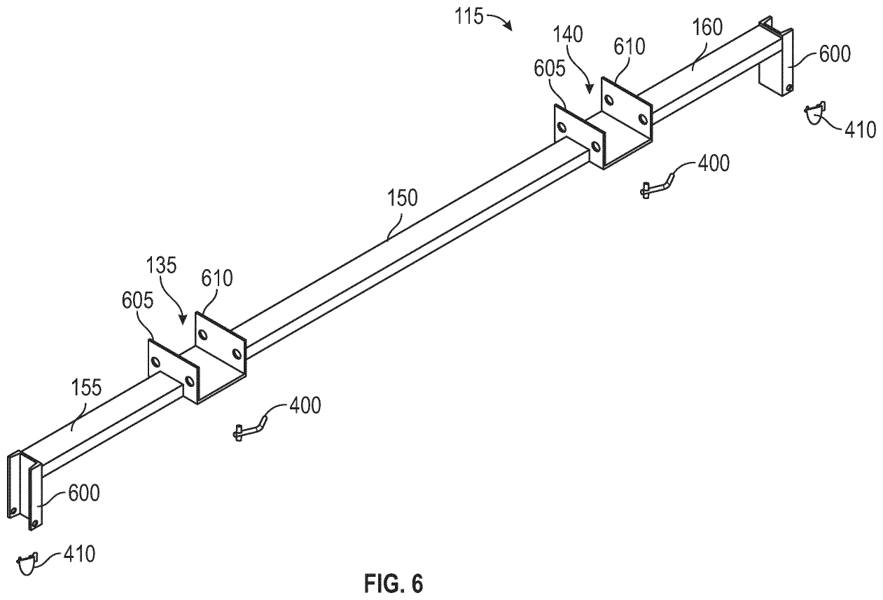

As shown in FIGS. 1 and 2, the cross members 115 are configured to couple to the trailer 105. Each cross member 115 extends across a lateral width of a floor, shown as deck 110, of the trailer 105. According to the exemplary embodiment shown in FIG. 1, the cross members 115 are substantially evenly spaced along a longitudinal length of the trailer 105. In some embodiments, the cross members 115 are not evenly spaced along the longitudinal length of the trailer 105. As shown in FIGS. 1 and 6, each cross member 115 includes a plurality of bracing portions (e.g., braces, slots, pockets, supports, interfaces, etc.), shown as first brace 135 and second brace 140. As shown in FIG. 1, the first braces 135 and the second braces 140 of the cross members 115 are configured to receive the first supports 120 and the second supports 125 and selectively couple the first supports 120 and the second supports 125 to the trailer 105, respectively. The first brace 135 and the second brace 140 are laterally spaced apart from each other along the cross member 115. In some embodiments, each cross member 115 includes more or fewer than two bracings (e.g., one bracing, three bracings, four bracings, etc.).

The first supports 120 and the second supports 125 are configured to support cargo (e.g., pipes, lumber, beams, blocks, machinery, construction equipment, vehicles, etc.), shown as rolled pipe 200, and provide a vertical space between the rolled pipe 200 and the deck 110 of the trailer 105. The first supports 120 and the second supports 125 are received by the first brace 135 and the second brace 140, respectively, such that the first supports 120 and the second supports 125 are laterally spaced from each other and extend parallel to each other in a longitudinal direction between the longitudinally spaced cross members 115. In some embodiments, the first supports 120 and the second supports 125 extend in a direction substantially perpendicular to the cross members 115. In some embodiments, the first supports 120 and the second supports 125 each include a plurality of (e.g., two or more) segments or portions of material sized to extend between the cross members 115. In some embodiments, the first supports 120 and the second supports 125 are 4 inch by 6 inch hardwood boards. In such embodiments, the first supports 120 and the second supports 125 may be received by the first brace 135 and the second brace 140 such that the 4 inch width of the first supports 120 and the second supports 125 extend laterally and the 6 inch height of the first supports 120 and the second supports 125 extend vertically. In some embodiments, the first supports 120 and the second supports 125 are manufactured from another material configured to support the rolled pipe 200 and provide a vertical space between the rolled pipe 200 and the deck 110 of the trailer 105 such as rubber, a plastic (e.g., high-density polyethylene, etc.), a metal (e.g., aluminum alloy), and/or any other suitable material. In other embodiments, the first supports 120 and the second supports 125 have other suitable dimensions. The first supports 120 and the second supports 125 may be substantially similar to or the same as each other.

As shown in FIGS. 2, 11, and 12, the storage rack 130 is configured to couple to the trailer 105 and store (e.g., secure, fasten, haul, support, etc.) the cross members 115, the first supports 120, and/or the second supports 125. The storage rack 130 may include one or more support members rigidly coupled to a portion of the trailer 105 (e.g., to a side of a frame of the trailer 105, to a lower surface of a frame of the trailer 105) and extending from the trailer 105 such that the cross members 115, the first supports 120, and/or the second supports 125 are supported by the storage rack 130. By way of example, when one or more cross members 115, first supports 120, and/or second supports 125 are not selectively coupled to the deck 110 of the trailer 105 (e.g., when one or more of the cross members 115, the first supports 120, and/or the second supports 125 are not supporting cargo), the one or more cross members 115, first supports 120, and/or second supports 125 may be secured to and stored by the storage rack 130. By way of another example, the storage rack 130 may store one or more spare (e.g., extra, additional, replacement, etc.) cross members 115, first supports 120, and/or second supports 125. The storage rack 130 may be positioned about the trailer 105 such that the storage rack 130 and the one or more cross members 115, first supports 120, and/or second supports 125 stored by the storage rack 130 do not impede the operations of a vehicle to which the trailer 105 is coupled (e.g., during loading/unloading operations, during driving operations, etc.). In some embodiments, two or more storage racks 130 are coupled to the trailer 105 (e.g., longitudinally spaced along a single side of the trailer 105, positioned on opposing lateral sides of the trailer 105, etc.) and configured to store the cross members 115, the first supports 120, and/or the second supports 125. In some embodiments, the storage rack 130 is configured to store one or more other components of the vehicle (e.g., wheels, tires, tools, equipment, etc.) and/or the load kit 100 (e.g., pins, straps, etc.).

As shown in FIG. 2, a pipe unloader mechanism, shown as pipe unloader 205, is coupled to a rear end of the trailer 105. In some embodiments, the trailer 105 does not include the pipe unloader 205. According to an exemplary embodiment, the pipe unloader 205 is configured to facilitate unloading the rolled pipe 200 from the trailer 105 during unloading procedures. The pipe unloader 205 includes one or more actuators configured to control the movement of one or more arms 210 relative to the trailer 105 and includes a ramp 215 positioned to provide a surface to roll the rolled pipe 200 in a direction towards the arms 210. After the rolled pipe 200 moves down the ramp 215, the arms 210 support the rolled pipe 200 and guide the rolled pipe 200 off of the trailer 105 such that the rolled pipe 200 is unloaded from the trailer 105. In some embodiments, the height of the first supports 120 and the second supports 125 is sufficiently sized such that the vertical space provided between a bottom surface of the rolled pipe 200 and the deck 110 of the trailer 105 is equal to or greater than a height of the ramp 215.

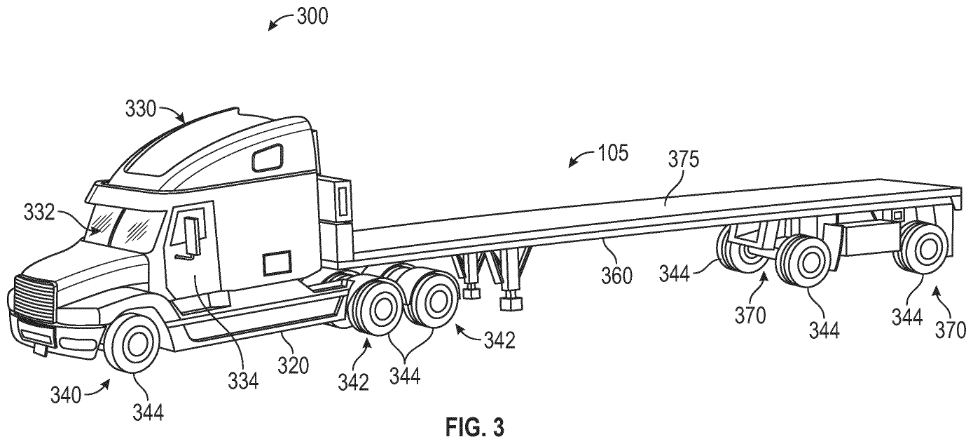

As shown in FIG. 3, a transportation vehicle (e.g., a vehicle assembly, a truck, etc.), shown as vehicle 300, is configured as a truck (e.g., a semi-tractor or semi-truck, such as a truck configured to haul a trailer partially or fully loaded with cargo). The vehicle 300 includes a frame assembly or chassis assembly, shown as chassis 320, that supports other components of the vehicle 300. The chassis 320 extends longitudinally along a length of the vehicle 300, substantially parallel to a primary direction of travel of the vehicle 300. In some embodiments, the chassis 320 includes a pair of frame rails that extend along a length of the vehicle 300. In other embodiments, the chassis 320 is otherwise configured (e.g., as a single, continuous piece, etc.).

As shown in FIG. 3, a cabin or operator compartment, shown as cab 330, is coupled to a front end portion of the chassis 320. Together, the chassis 320 and the cab 330 define a front end of the vehicle 300. The cab 330 extends above the chassis 320. The cab 330 includes an enclosure or main body that defines an interior volume, shown as cab interior 332, that is sized to accommodate one or more operators and/or passengers. The cab 330 also includes one or more doors 334 that facilitate selective access to the cab interior 332 from outside of the vehicle 300. The cab interior 332 contains one or more components that facilitate operation of the vehicle 300 by the operator. By way of example, the cab interior 332 may contain components that facilitate operator comfort (e.g., seats, seatbelts, etc.), user interface components that receive inputs from the operators (e.g., steering wheels, pedals, touch screens, switches, buttons, levers, etc.), and/or user interface components that provide information to the operators (e.g., lights, gauges, speakers, etc.). The user interface components within the cab 330 may facilitate operator control over the drive components of the vehicle 300 and/or over any implements of the vehicle 300.

As shown in FIG. 3, the vehicle 300 includes a series of axle assemblies or tractive assemblies, shown as front axle 340 and rear axles 342. As shown, the vehicle 300 includes one front axle 340 coupled to the chassis 320 near a front end of the vehicle 300 and two rear axles 342 (e.g., a tandem rear axle) coupled to the chassis 320 near a rear end of the vehicle 300. In other embodiments, the vehicle 300 includes more or fewer axles (e.g., one rear axle 342). The front axle 340 and the rear axles 342 each include a plurality of tractive elements (e.g., wheels, treads, etc.), shown as wheel and tire assemblies 344. The wheel and tire assemblies 344 are configured to engage a support surface (e.g., roads, the ground, etc.) to support and propel the vehicle 300. The front axle 340 and the rear axle 342 may include steering components (e.g., steering arms, steering actuators, etc.), suspension components (e.g., gas springs, dampeners, air springs, etc.), power transmission or drive components (e.g., differentials, drive shafts, etc.), braking components (e.g., brake actuators, brake pads, brake discs, brake drums, etc.), and/or other components that facilitate propulsion or support of the vehicle 300.

As shown in FIG. 3, the vehicle 300 includes the trailer 105, coupled to a rear end of the vehicle 300. The trailer 105 includes a chassis, shown as trailer frame 360, a plurality of axles and wheel assemblies, shown as trailer axles 370, coupled to the trailer frame 360, and a rear body, floor, platform, etc., shown as flatbed 375, coupled to the trailer frame 360. The flatbed 375 may be a substantially flat surface or deck (e.g., the deck 110) configured to support and facilitate securing (e.g., store, fasten, support, carry, etc.) cargo (e.g., cars, equipment, etc.) during transportation.

In some embodiments, the flatbed 375 is sized according to standard dimensions including: (a) a longitudinal length between a front end and a rear end of the flatbed 375 of 53 feet and (b) a lateral width between a left side and a right side of the flatbed 375 of 8 feet 6 inches. In other embodiments, the flatbed 375 is a different size or dimension (e.g., a longitudinal length of 48 feet, a lateral width of 8 feet, etc.). The dimensions of the flatbed 375 may vary depending on the cargo stored on the flatbed 375 and the intended application of the vehicle 300.

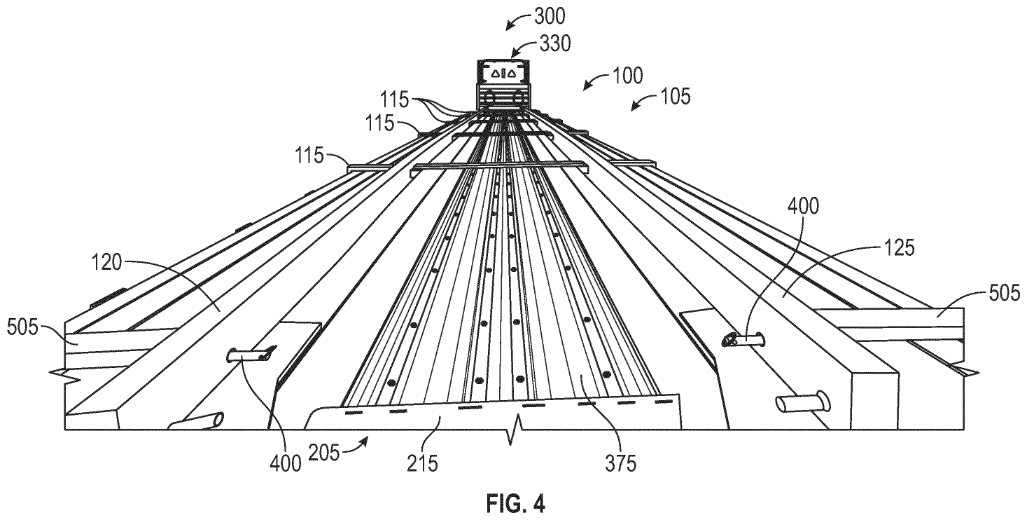

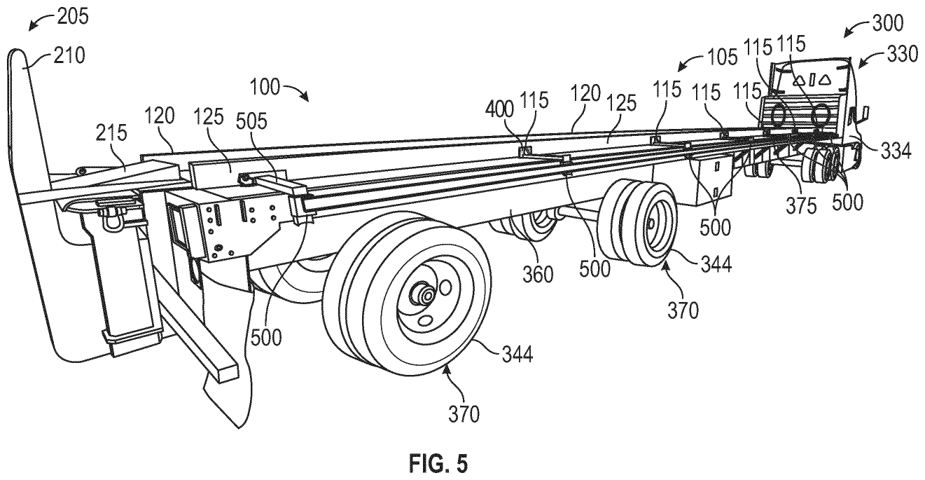

As shown in FIGS. 4 and 5, the load kit 100 is installed onto the trailer 105. The cross members 115 extend across a lateral width of the flatbed 375 and are spaced longitudinally from each other along the length of the flatbed 375. In some embodiments, the longitudinal length of the flatbed 375 is 53 feet. In such embodiments, six cross members 115 may be coupled to the flatbed 375 and evenly spaced along the length of the flatbed 375 longitudinally in increments of about 8 feet. In other embodiments, the load kit 100 includes more or fewer than six cross members 115. In yet other embodiments, the cross members 115 are not evenly spaced longitudinally from each other. In other embodiments, the number of cross members 115 and the dimensions of the longitudinal spacing between the cross members 115 may vary depending on the longitudinal length of the flatbed 375 (e.g., the longitudinal length of the trailer 105) and the intended application of the vehicle 300.

As shown in FIGS. 4 and 5, the cross members 115 couple the first supports 120 and the second supports 125 to the flatbed 375. The first supports 120 are received by the first braces 135 of the cross members 115. The second supports 125 are received by the second braces 140 of the cross members 115. The first supports 120 and the second supports 125 are laterally spaced from each other and extend parallel to each other in a longitudinal direction along the length of the flatbed 375. By way of example, the first supports 120 and the second supports 125 extend in a direction between the cab 330 and the ramp 215 of the pipe unloader 205 coupled to a rear end of the trailer 105. The vertical distance from the flatbed 375 to a top surface of the first supports 120 (e.g., the height of the first supports 120) is substantially similar to the vertical distance from the flatbed 375 to a top surface of the second supports 125 (e.g., the height of the second supports 125), such that when the rolled pipe 200 is placed on the trailer 105, the rolled pipe 200 is substantially evenly supported by the first supports 120 and the second supports 125. The first supports 120 and the second supports 125 may be suitably positioned and dimensioned such that the height of the first supports 120 and the height of the second supports 125 is equal to or greater than a height of the ramp 215 of the pipe unloader 205. In embodiments where the longitudinal length of the flatbed 375 is 53 feet and six cross members 115 are coupled to the flatbed 375, the first supports 120 and the second supports 125 may be each comprised of six 8 foot sections of material and one 5 foot section of material. By way of example, the six 8 foot sections of the first supports 120 and the second supports 125 may be positioned end-to-end (e.g., in series) extending from a front end of the trailer 105 in a direction towards the rear end of the trailer 105 and coupled to the flatbed 375 by the cross members 115. The one 5 foot section of the first supports 120 and the second supports 125 may be positioned proximate the rear end of the trailer 105 and coupled to the flatbed 375 by a cross member 115. In other embodiments, the number of first supports 120 and second supports 125 and the dimensions of the first supports 120 and the second supports 125 may vary depending on the longitudinal length of the flatbed 375 (e.g., the longitudinal length of the trailer 105) and the intended application of the vehicle 300.

As shown in FIGS. 4 and 5, the first supports 120 and the second supports 125 are received by the first braces 135 and the second braces 140, respectively, and secured within the first braces 135 and the second braces 140 by way of one or more first fasteners (e.g., pins, bolts, nails screws, clamps, locks, etc.), shown as pins 400. The first brace 135 and the second brace 140 each define one or more apertures shaped to receive the pin 400. Similarly, the first support 120 and the second support 125 define one or more apertures shaped to receive the pins 400. The pins 400 may extend through (a) the apertures defined by the first brace 135 and the apertures defined by the first support 120 and (b) the apertures defined by the second brace 140 and the apertures defined by the second support 125 to secure the first support 120 and the second support 125 to the cross member 115 and, thereby, couple the first support 120 and the second support 125 to the flatbed 375. By way of example, a first pin 400 may extend through (i) an aperture in a first flange of the first brace 135, (ii) an aperture in the first support 120, and (iii) an aperture in a second flange of the first brace 135 to couple the first support 120 to the cross member 115. By way of another example, a second pin 400 may extend through (i) an aperture in a first flange of the second brace 140, (ii) an aperture in the second support 125, and (iii) an aperture in a second flange of the second brace 140 to couple the second support 125 to the cross member 115. Two or more pins 400 may be used at each bracing (e.g., at each first brace 135, at each second brace 140) to couple the two first supports 120 and the two second supports 125 to a respective cross member 115. The pins 400 include an aperture extending through an end of the pins 400 that is configured to receive a retainer (e.g., a cotter pin). The opposite end of the pin 400 may be shaped (e.g., bent) to prevent the pin 400 from extending (e.g., sliding) entirely through the apertures of (a) the first brace 135 and the first support 120 and (b) the second brace 140 and the second support 125, respectively. The retainers are configured to extend through the aperture of the pins 400 to prevent unintentional dislodgement or removal of the pins 400. In some embodiments, the first supports 120 and the second supports 125 are secured within the first braces 135 and the second braces 140, respectively, by way of another suitable fastening mechanism and/or system.

As shown in FIGS. 5, 7, and 8, the load kit 100 includes a plurality of receiving members (e.g., side rails, cleats, holders, slots, attachment points, interfaces, retainers, etc.), shown as stake pockets 500. The stake pockets 500 are coupled along (e.g., bolted, welded, etc.) the sides of the trailer 105 (e.g., along a left side rail and a right side rail of the trailer frame 360 or the flatbed 375) and spaced along the longitudinal length of the trailer 105. In some embodiments, the stake pockets 500 may be otherwise positioned about the trailer 105. The stake pockets 500 are shown as being substantially rectangular members that provide an attachment location to facilitate securing cargo on the flatbed 375. The stake pockets 500 define an opening (e.g., an inner cavity, an aperture, a slot, etc.) through which the cross members 115 (or a portion thereof) may be received and selectively secured to the trailer 105 and across the flatbed 375 by way of one or more second fasteners, shown as pins 410. In some embodiments, the pins 410 used to secure the cross members 115 within the stake pockets 500 are larger or smaller than the pins 400 used to secure the first supports 120 and the second supports 125 within the first braces 135 and the second braces 140, respectively. In some embodiments, the cross members 115 are secured to the trailer 105 within the stake pockets 500 by way of another fastening mechanism. In some embodiments, the stake pockets 500 provide an attachment location for straps, chains, hooks, etc. for load securement.

As shown in FIGS. 4 and 5, the load kit 100 includes one or more support members (e.g., board bracings, load support members, rails, etc.), shown as support rail 505, coupled to the flatbed 375 by way of the stake pockets 500 and pins 410. The support rail 505 may be positioned proximate the rear end of the flatbed 375 and configured to support the first support 120 and the second support 125. The support rail 505 may be coupled to the first support 120 and the second support 125 positioned proximate the rear end of the flatbed 375 to secure the respective ends of the first support 120 and the second support 125 located proximate the rear end of the flatbed 375. In some embodiments, the load kit 100 does not include the support rail 505. In such embodiments, the respective ends of the first support 120 and the second support 125 located proximate the rear end of the flatbed 375 may be secured to the flatbed 375 using a cross member 115. In yet other embodiments, the respective ends of the first support 120 and the second support 125 located proximate the rear end of the flatbed 375 are secured to the flatbed 375 by way of another system and/or method. The load kit 100 may include two support rails 505 configured to be positioned on opposing lateral sides of the trailer 105, and each configured to couple to a respective one of the first support 120 and the second support 125. The two support rails 505 may be similar to the cross member 115 disclosed herein, but not include the central tube 150 described herein. By way of example, each of the support rails 505 may include a stake, a bracing, and a lateral tube element extending between the stake and bracing (as described in more detail herein with respect to the cross members 115).

As shown in FIG. 6, the cross member 115 includes the first brace 135; the second brace 140; a pair of securing members (e.g., stakes, posts, retainers, vertical members, etc.), shown as stakes 600, positioned at opposing lateral ends of the cross member 115 and extending vertically downward; a first lateral frame element, shown as central tube 150, extending between the first brace 135 and the second brace 140; a second lateral frame element, shown as first end tube 155, extending between the first brace 135 and a first stake 600; and a third lateral frame element, shown as second end tube 160, extending between the second brace 140 and a second stake 600. The stakes 600 extend in a direction perpendicular to the direction of extension of the cross member 115 across the flatbed 375. The stakes 600 are configured to be received by the stake pockets 500 and secured therein by way of the pins 410. The stakes 600 define apertures extending through a first flange and a second flange thereof. A respective pin 410 may extend through the apertures of the first flange and the second flange of a respective stake 600 when the stake 600 is slotted through the opening defined by the stake pockets 500 to secure the cross member 115 to the trailer 105.

As shown in FIG. 6, the first brace 135 and the second brace 140 are shaped to receive the first supports 120 and the second supports 125, respectively. In some embodiments, the first brace 135 and the second brace 140 are U-shaped. In other embodiments, the first brace 135 and the second brace 140 are otherwise shaped (e.g., rectangular). The first brace 135 and the second brace 140 each include a first flange 605 and a second flange 610. The first flange 605 and the second flange 610 are laterally spaced from each other and extend upwards in a vertical direction from the flatbed 375. In some embodiments, the lateral distance between the first flange 605 and the second flange 610 is suitably sized such that the first brace 135 and the second brace 140 can receive the first supports 120 and the second supports 125, respectively. By way of example, when the lateral width of the first supports 120 and the second supports 125 is 4 inches, the lateral distance between the first flange 605 and the second flange 610 may be substantially equal to or greater than 4 inches (e.g., 4.25 inches, 4.5 inches, 5 inches, 6 inches, etc.). The first flange 605 and the second flange 610 each include two apertures shaped to receive the pins 400 to secure the first support 120 and the second support 125 to the flatbed 375. In some embodiments, the first flange 605 and the second flange 610 each include more or fewer than two apertures shaped to receive the pins 400. The first flange 605 and the second flange 610 may support the first supports 120 and the second supports 125 to prevent the first supports 120 and the second supports 125 from sliding, slipping, etc. when the rolled pipe 200 is supported by the first supports 120 and the second supports 125 on the trailer 105.

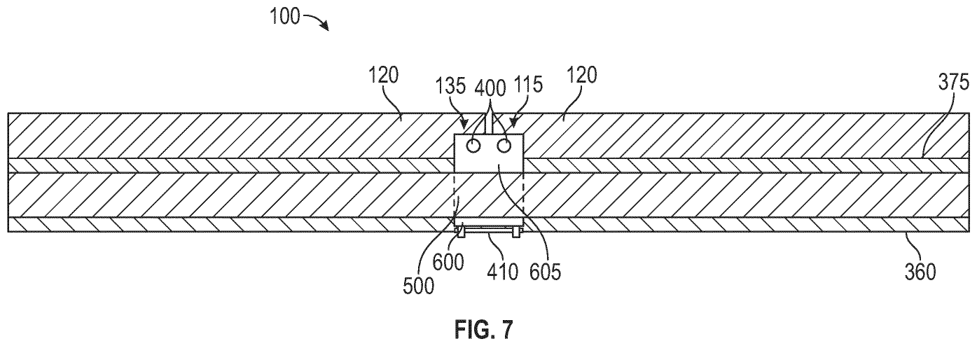

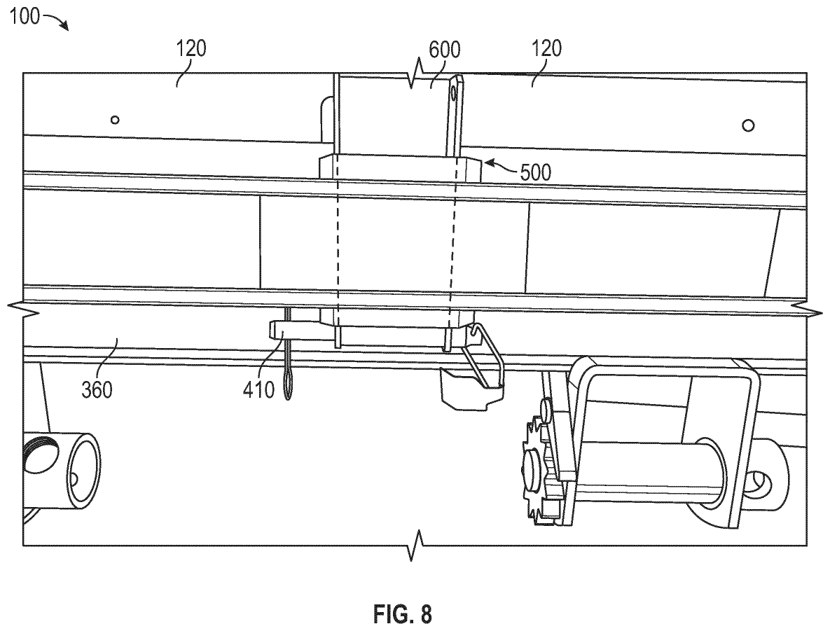

As shown in FIGS. 7 and 8, the stake 600 of the cross member 115 extends through the slot defined by the stake pocket 500 to secure the cross member 115 to the trailer 105. The stake 600 is sized such that at least a portion of the stake 600 extends entirely through and out the bottom of the slot defined by the stake pocket 500. The portion of the stake 600 that extends entirely through and out of the slot defined by the stake pocket 500 defines the apertures through which the pin 410 extends to secure the stake 600 within the stake pocket 500 and, thereby, the cross member 115 to the trailer 105. In some embodiments, the cross member 115 is secured to the trailer 105 by way of another system and/or method. By way of example, the cross member 115 may be selectively coupled to the trailer 105 using bolts, clamp-on mounts, tie-downs, etc.

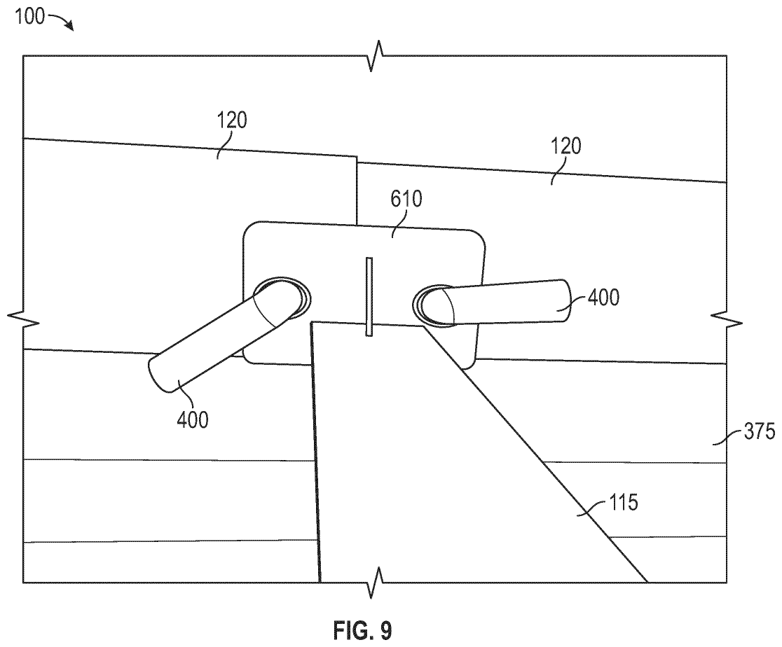

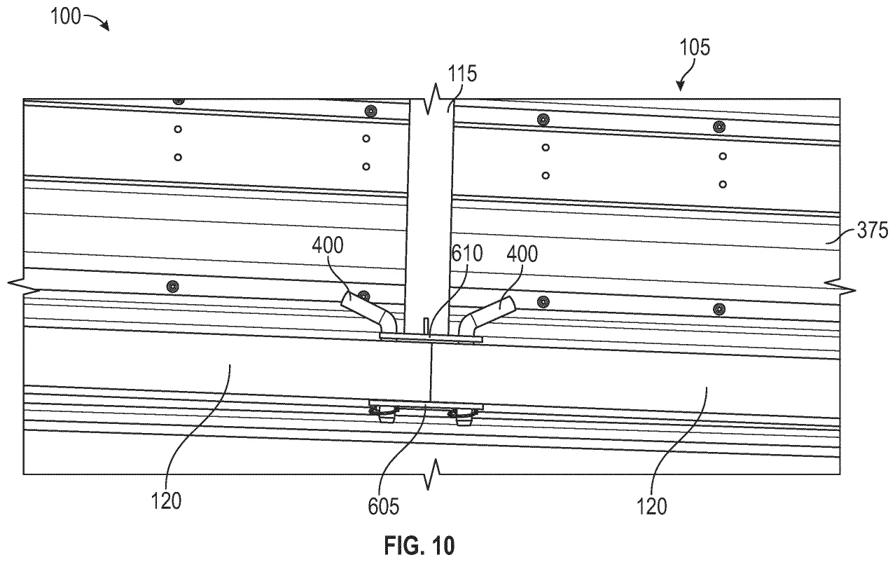

As shown in FIGS. 7, 9, and 10, the first supports 120 and the second supports 125 are received in the first braces 135 and the second braces 140, respectively, and secured to the flatbed 375 by one or more pins 400. As shown, the ends of the adjacent first supports 120 interface (e.g., contact, abut, meet, etc.) with each other at a location within the first brace 135. Similarly, the ends of the adjacent second supports 125 interface (e.g., contact, abut, meet, etc.) with each other at a location within the second brace 140. The location where the ends of the first supports 120 and the ends of the second supports 125 interface may be substantially centered within the first brace 135 and the second brace 140, respectively. The first supports 120 and the second supports 125 define an aperture proximate the interface between the ends of the first supports 120 and the second supports 125. By way of example, to secure the first supports 120 to the first braces 135 of the cross members 115, (a) a first pin 400 is configured to extend through (i) a first aperture defined by the first flange 605 of the first brace 135, (ii) an aperture defined by a first or frontward first support 120, and (iii) a first aperture defined by the second flange 610 of the first brace 135, and (b) a second pin 400 is configured to extend through (i) a second aperture defined by the first flange 605 of the first brace 135, (ii) an aperture defined by a second or rearward first support 120, and (iii) a second aperture defined by the second flange 610 of the first brace 135. Similarly, this process may be repeated at the second braces 140 to secure the second supports 125 to the second braces 140 of the cross members 115. In other embodiments, the location where the ends of the first supports 120 and the ends of the second supports 125 interface is not centered within the first brace 135 and the second brace 140, respectively.

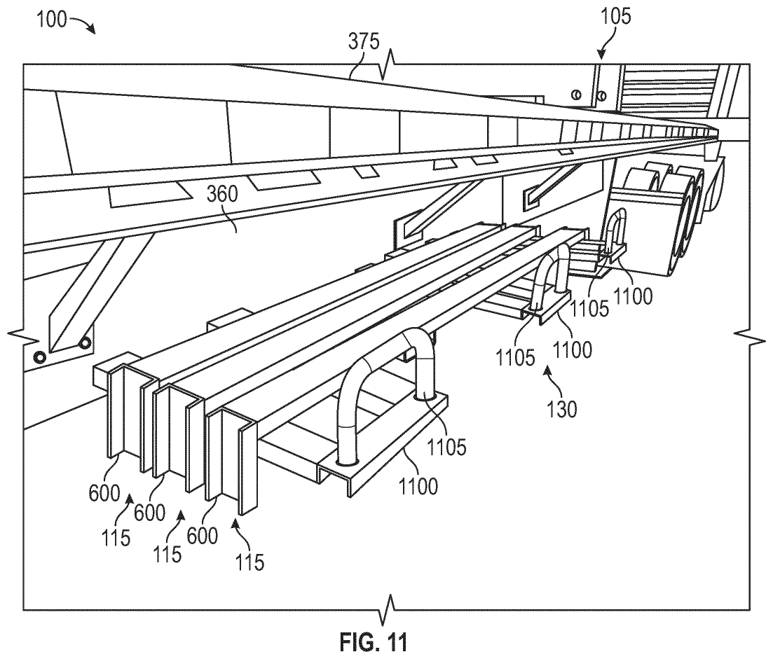

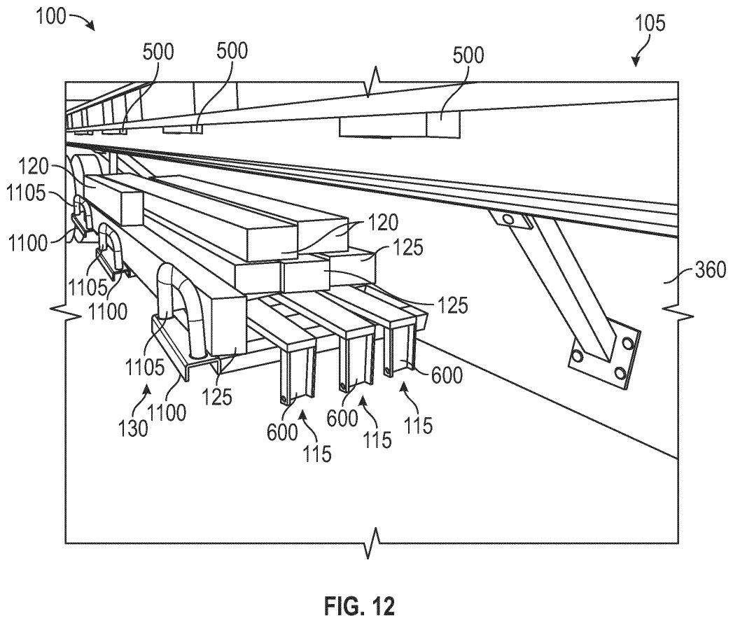

As shown in FIGS. 11 and 12, the storage rack 130 is configured to couple to the trailer 105 and store (e.g., secure, fasten, haul, support, etc.) the cross members 115, the first supports 120, and/or the second supports 125. As shown, the storage rack 130 is coupled to the trailer frame 360 (e.g., bolted, welded, etc.). In some embodiments, the storage rack 130 is coupled to a portion of the trailer 105 (e.g., the trailer frame 360, a lower surface of a frame of the trailer 105, etc.) and extends from the trailer 105 such that the cross members 115, the first supports 120, and/or the second supports 125 can be laid along and supported by the storage rack 130. By way of example, when one or more of the cross members 115, the first supports 120, and/or the second supports 125 are not selectively coupled to the flatbed 375 or deck 110 of the trailer 105 (e.g., when one or more of the cross members 115, the first supports 120, and/or the second supports 125 are not supporting cargo), the one or more cross members 115, the first supports 120, and/or the second supports 125 may be secured by the storage rack 130. By way of another example, the storage rack 130 may store one or more spare (e.g., extra, additional, replacement, etc.) cross members 115, first supports 120, and/or second supports 125. The storage rack 130 may be positioned about the trailer 105 such that the storage rack 130 and the one or more cross members 115, first supports 120, and/or second supports 125 stored by the storage rack 130 do not impede the operations of the vehicle 300 (e.g., loading/unloading operations, driving operations, etc.). In some embodiments, two or more storage racks 130 are coupled to the trailer 105 and configured to store the cross members 115, the first supports 120, and/or the second supports 125. In some embodiments, the storage rack 130 is configured to store one or more other components of the vehicle 300 (e.g., wheels, tire assemblies 344, tools, equipment, etc.) and/or the load kit 100 (e.g., pins 400, pins 410, straps, etc.).

As shown in FIGS. 11 and 12, the storage rack 130 includes three support members, shown as storage supports 1100, coupled to the trailer frame 360, spaced longitudinally along one of the sides of the trailer 105, and extending outward in a lateral direction from the trailer 105. In some embodiments, the storage rack 130 includes more or fewer than three storage supports 1100. The storage supports 1100 include a vertical member, shown as end retainer 1105, extending vertically upwards from a free end thereof and configured to substantially prevent lateral movement of the one or more cross members 115, first supports 120, and/or second supports 125 stored by the storage rack 130. By way of example, when the vehicle 300 is driving along a route (e.g., on a road, on a trail, etc.), the end retainers 1105 may prevent the one or more cross members 115, first supports 120, and/or second supports 125 stored by the storage rack 130 from falling off of the side of the storage rack 130. In some embodiments, all of the storage supports 1100 do not include a corresponding end retainer 1105 (e.g., only the front and rear storage supports 1100 include end retainers 1105, only the middle storage support 1100 includes the end retainer 1105, etc.).

The storage supports 1100 may be spaced along the longitudinal length of the trailer frame 360 such that the longitudinal distance between the front and rear edges of the storage rack 130 is equal to or less than the length of the cross members 115 (e.g., the distance between the stakes 600). By way of example, when the lateral width of the flatbed 375 is 8 feet 6 inches, the length of the cross members 115 (e.g., the distance between the stakes 600) may be equal to or greater than 8 feet 6 inches, and the longitudinal distance between the front and rear edges of the storage rack 130 may be equal to or less than 8 feet 6 inches (e.g., so that the stakes 600 extend beyond the front and rear edges of the storage rack 130 and can engage therewith to prevent longitudinal movement thereof). In some embodiments, the storage rack 130 and the components thereof (e.g., the storage supports 1100, the end retainers 1105, etc.) may be otherwise suitably spaced and/or dimensioned to store the cross members 115, the first supports 120, and/or the second supports 125.

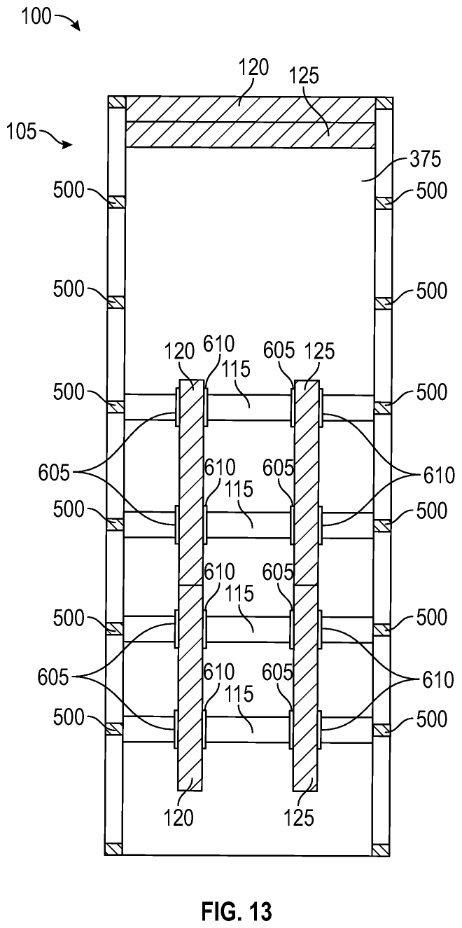

The various components of the load kit 100 (e.g., cross members 115, first supports 120, second supports 125, etc.) are configured to selectively couple to the trailer 105 and/or the flatbed 375 such that the vehicle 300, the trailer 105, and/or the flatbed 375 is capable of securing (e.g., transporting, carrying, loading, etc.) a mixed load (e.g., different types of loads), a rolled load (e.g., rolled pipe 200), or a flat load (e.g., boxes, containers, square cargo, rectangular cargo, etc.). As shown in FIG. 13, one or more cross members 115 and the associated sections or segments of the first supports 120 and the second supports 125 that would be secured by the one or more cross members 115 may be selectively removed (e.g., not coupled to the trailer 105, not installed, etc.) to provide a space on the flatbed 375 for securing a load of a different type than the rolled pipe 200. By way of example, the one or more sections of the flatbed 375 where the one or more cross members 115 and the associated sections or segments of the first supports 120 and the second supports 125 are removed (e.g., consecutive cross members 115 and the associated sections or segments of first supports 120 and second supports 125) may be capable of carrying a load of a first type (e.g., palletized cargo, boxed cargo, square cargo, rectangular cargo, flat cargo, etc.). The one or more sections or segments of the flatbed 375 where the one or more cross members 115 and the associated sections or segments of the first supports 120 and the second supports 125 are installed may be capable of carrying a load of a second type (e.g., rolled material, rolled pipe 200, circular material, round load, tubular load, etc.) that is different from the first type. The removed cross members 115 and associated sections or segments of the first supports 120 and the second supports 125 may be stored (e.g., secured) on the trailer 105 using the storage rack 130. In some embodiments, the removed cross members 115 and associated sections of the first supports 120 and the second supports 125 can be stored (e.g., secured) on the flatbed 375 proximate the front end of the flatbed 375. In other embodiments, the removed cross members 115 and associated sections or segments of the first supports 120 and the second supports 125 can be stored (e.g., secured) on the flatbed 375 proximate the rear end of the flatbed 375. In some embodiments, removing additional cross members 115 and the associated sections or segments of the first supports 120 and the second supports 125 provides a larger space/section on the flatbed 375 for carrying flat load cargo. In some embodiments, the cross members 115 and the associated sections or segments of the first supports 120 and the second supports 125 are not installed on the front half of the trailer 105 to facilitate carrying flat load cargo and are installed on the rear half of the trailer 105 to facilitate carrying rolled cargo (e.g., the rolled pipe 200). In other embodiments, cross members 115 and the associated sections or segments of the first supports 120 and the second supports 125 are not installed on the rear half of the trailer 105 to facilitate carrying flat load cargo and are installed on the font half of the trailer 105 to facilitate carrying rolled cargo (e.g., the rolled pipe 200).

As utilized herein with respect to numerical ranges, the terms “approximately,” “about,” “substantially,” and similar terms generally mean+/−10% of the disclosed values. When the terms “approximately,” “about,” “substantially,” and similar terms are applied to a structural feature (e.g., to describe its shape, size, orientation, direction, etc.), these terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure.

It is important to note that the construction and arrangement of the vehicle 300 and load kit 100 as shown in the various exemplary embodiments is illustrative only. Additionally, any element disclosed in one embodiment may be incorporated or utilized with any other embodiment disclosed herein. Although only one example of an element from one embodiment that can be incorporated or utilized in another embodiment has been described above, it should be appreciated that other elements of the various embodiments may be incorporated or utilized with any of the other embodiments disclosed herein.

1. A load kit for supporting a load on a flatbed of a trailer, the load kit comprising:
a cross member configured to extend across a lateral width of the flatbed and selectively couple to the trailer, the cross member including:
a first brace; and
a second brace laterally spaced from the first brace;
a first support configured to be received by the first brace and extend along at least a portion of a longitudinal length of the flatbed; and
a second support configured to be received by the second brace and extend along at least a portion of the longitudinal length of the flatbed.

2. The load kit of claim 1, further comprising a storage rack configured to support the cross member, the first support, and the second support when the cross member, the first support, and the second support are positioned along the flatbed.

3. The load kit of claim 2, wherein the storage rack is configured to couple to a frame of the trailer.

4. The load kit of claim 3, wherein the storage rack includes:
a storage support configured to couple to and extend in a lateral direction from the frame of the trailer; and
a retainer extending vertically upwards from a free end of the storage support.

5. The load kit of claim 1, wherein the first support and the second support are configured to support the load.

6. The load kit of claim 5, wherein the first support and the second support are configured to provide a vertical space between the flatbed and the load.

7. The load kit of claim 6, wherein the trailer includes a pipe unloader including a ramp, and wherein the vertical space provided between the flatbed and the load is equal to or greater than a vertical height of the ramp.

8. The load kit of claim 7, wherein the load has a curved shape.

9. The load kit of claim 1, further comprising a plurality of fasteners, wherein a first fastener of the plurality of fasteners is configured to selectively couple the first support within the first brace, and wherein a second fastener of the plurality of fasteners is configured to selectively couple the second support within the second brace.

10. The load kit of claim 1, wherein the cross member includes a first retainer positioned at a first lateral end thereof and a second retainer positioned at an opposing second lateral end thereof, and wherein the first retainer and the second retainer are configured to facilitate selectively coupling the cross member to the trailer.

11. The load kit of claim 10, further comprising a plurality of interfaces including a first interface configured to be coupled to a first lateral side of the trailer and a second interface configured to be coupled to an opposing second lateral side of the trailer, and wherein the first retainer is configured to selectively engage with the first interface and the second retainer is configured to selectively engage with the second interface to facilitate selectively coupling the cross member to the trailer.

12. The load kit of claim 1, further comprising a plurality of cross members including the cross member configured to be spaced along the longitudinal length of the flatbed, wherein the first support and the second support are configured to extend between the plurality of cross members.

13. The load kit of claim 12, wherein the first support includes a plurality of first segments and the second support includes a plurality of second segments.

14. The load kit of claim 13, wherein a first end of a first segment of the plurality of first segments is configured to interface with a second end of a second segment of the plurality of first segments within the first brace of a respective cross member of the plurality of cross members, and wherein a first end of a first segment of the plurality of second segments is configured to interface with a second end of a second segment of the plurality of second segments within the second brace of the respective cross member.

15. A trailer for a truck, the trailer comprising:
a chassis;
a flatbed coupled to the chassis;
a plurality of interfaces positioned along a longitudinal length of the chassis;
a plurality of cross members configured to selectively engage with the plurality of interfaces;
a plurality of first supports configured extend along at least a portion of the longitudinal length of the trailer, the plurality of first supports configured to selectively couple with the plurality of cross members;
a plurality of second supports configured extend along at least a portion of the longitudinal length of the trailer and be laterally spaced from the plurality of first supports, the plurality of second supports configured to selectively couple with the plurality of cross members; and
a storage rack configured to couple to the chassis, the storage rack configured to selectively store the plurality of cross members, the plurality of first supports, and the plurality of second supports.

16. The trailer of claim 15, wherein at least a portion of each cross member of the plurality of cross members is configured to be received within a respective one of the plurality of interfaces.

17. The trailer of claim 15, wherein the plurality of first supports and the plurality of second supports are configured to support a load and provide a vertical space between the load and the flatbed.

18. The trailer of claim 17, wherein:
the load is a first load of a first type;
the trailer is configured to support the first load on a first section when the plurality of cross members, the plurality of first supports, and the plurality of second supports are selectively coupled to the first section of the flatbed; and
the trailer is configured to support a second load of a second type different than the first type on a second section of the flatbed.

19. The trailer of claim 15, wherein the plurality of cross members are configured to extend across a lateral width of the flatbed, and wherein the plurality of first supports and the plurality of second supports are configured to extend substantially perpendicular to the plurality of cross members.

20. A method for converting a trailer having a flatbed and interfaces positioned along opposing sides of the flatbed, the method comprising:
providing a cross member, a first support, a second support, a first pin, a second pin, a third pin, and a fourth pin, the cross member having a first retainer positioned at a first end thereof, a second retainer positioned at opposing second end thereof, a first brace positioned between the first end and the second end closer to the first end, and a second brace positioned between the first end and the second end closer to the second end;
inserting the first retainer into a first interface of the interfaces and the second retainer into a second interface of the interfaces such that the cross member extends across a lateral width of the flatbed;
inserting the first pin through the first retainer to secure the first retainer within the first interface;
inserting the second pin through the second retainer to secure the second retainer within the second interface;
disposing the first support within the first brace;
disposing the second support within the second brace;
inserting the third pin through the first brace and the first support to secure the first support to the cross member; and
inserting the fourth pin through the second brace and the second support to secure the second support to the cross member.
